(19) United States
(12) Patent Application Publication
(10) Pub. No.: US 2003/0043172 A1
(43) Pub. Date: Mar. 6, 2003

(54) Extraction of textual and graphic overlays from video

(76) Inventors: Huiping Li, Silver Spring, MD (US); Thomas M. Strat, Oakton, VA (US)

Correspondence Address: Venable, P.O. Box 34385, Washington, DC, 20043-9998, US

(21) Appl. No.: 09/935,610

(22) Filed: Aug. 24, 2001

(51) Int. Cl. G09G 5/00

(52) U.S. Cl. 345/636

(57) ABSTRACT

A method for extracting textual and graphical overlays from video sequences involves steps of detecting a potential overlay in a video sequence and then verifying that the potential overlay is an actual overlay. Detection of textual overlays involves wavelet decomposition and neural network processing, while detection of graphical overlays involves template matching. Verification of textual and graphical overlays involves spatial and/or temporal verification.

### FIELD OF INVENTION

The present invention generally lies in the field of video image processing. More particularly, the present invention deals with decomposition of video images and, specifically, with the extraction of text and graphic overlays from video.

### BACKGROUND OF THE INVENTION

Text and graphics overlays are often inserted into video during post-production editing. Examples of such overlays include logos for network identification, scoreboards for sporting events, names and affiliations of interviewers and people they are interviewing, and credits. The addition of such overlays permits the transmission of extra information, above and beyond the video content itself.

The extraction of such text and graphics overlays from video is, however, a difficult problem, which has had only limited treatment in the prior art. However, when such extraction can be performed, it affords a number of potential benefits in various video processing applications. Such applications include compression, indexing and retrieval, logo detection and recognition, and video manipulation.

Current compression techniques tend to be especially susceptible to inefficiencies when presented with overlays of text or graphics. Without special treatment, those overlays are illegible, especially in video compressed at low bit rates. If such overlays can be detected and segmented from the rest of the video, greater efficiency can be achieved by compressing the overlay as a static image, resulting in a more readable overlay, even at low bit rates.

Extraction of an overlay from the underlying video is also useful to enable rapid retrieval of video segments. Optical character recognition (OCR) performing on video frames performs poorly if the location of the text is not known. However, OCR performed on the overlay is more robust. The OCR results can then be used in a system for rapid retrieval of the video segment, based on textual content.

Extraction of logos and “watermarks” from video segments, placed there by broadcasters and/or owners of video content, are often used for branding and/or copyright enforcement. Extraction of such logos permits more efficient compression, via independent compression and reinsertion, and it can aid in the enforcement of intellectual property rights in the video content.

Being able to extract overlays also permits general overlay manipulation to re-create the video with modified content. For example, one overlay may be substituted for another one extracted from the video, styles may be changed, text may be changed, language may be changed, errors may be corrected, or the overlay may be removed, altogether. As a pre-processing step to a video non-linear editing process, overlay extraction makes it possible to modify the overlay independently from the underlying video, without the need for the time-consuming processing of frame-by-frame editing.

Extracting overlays from video is complicated by several factors that have prevented earlier attempts from achieving the degree of reliability needed for commercial applications:

A textual overlay may consist of characters from various type fonts, sizes, colors, and styles.

A textual overlay may consist of characters from various alphabets, and the words may be from various languages.

The extraction method must be able to separate text in an overlay (overlay text) from text that is part of the video scene (scene text).

The extraction method must be able to separate overlays that are opaque (the video can not be seen between the characters); and overlays that are partially or completely transparent.

The extraction method must be able to separate overlays from video that is obtained by either stationary or moving cameras.

Therefore, it would be highly beneficial, and it is an object of the present invention, to provide a means by which to perform robust extraction of overlays from video.

### SUMMARY OF THE INVENTION

The present invention provides a method and system for the detection and extraction of text and graphical overlays from video.

In general, the technique, according to a preferred embodiment of the invention, involves the detection of areas that may correspond to text overlays, followed by a process of verifying that such candidate areas are, in fact, text overlays. In an embodiment of the invention, the detection step is performed using neural network-based methods. Also in an embodiment of the invention, the verification process comprises steps of spatial and temporal verification. The technique, as applied to graphical overlays, according to a preferred embodiment of the invention, includes a template-based approach. The template may comprise the actual overlay, or it may comprise size and location (within a video frame) information. Given a graphical overlay template, the overlay may be detected in the video and tracked temporally for verification, in an embodiment of the invention. In one embodiment of the invention, a template may be obtained via addition of video frames or via frame-by-frame subtraction. In another embodiment of the invention, the +emplate may be obtained in images involving a moving observer (e.g., video camera) by segmenting the image into foreground (moving) and background components; if a foreground component happens to remain in the same location in the video frame over a number of frames, despite observer motion, then it is deemed to be an overlay and may be used as a template.

Definitions

In describing the invention, the following definitions are applicable throughout (including above).

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a microcomputer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, like a CD-ROM or a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links.

Examples of a network include: an internet, such as the Internet; an intranet; a local area network (LAN); a wide area network (WAN); and a combination of networks, such as an internet and an intranet.

“Video” refers to motion pictures represented in analog and/or digital form. Examples of video include television, movies, image sequences from a camera or other observer, and computer-generated image sequences. These can be obtained from, for example, a live feed, a storage device, a firewire interface, a video digitizer, a computer graphics engine, or a network connection.

“Video processing” refers to any manipulation of video, including, for example, compression and editing.

A “frame” refers to a particular image or other discrete unit within a video.

### BRIEF DESCRIPTION OF THE DRAWINGS

Embodiments of the invention will now be described in conjunction with the drawings, in which:

FIG. 1 shows a high-level flowchart of an embodiment of the invention;

FIG. 2 shows an embodiment of the detection process shown in FIG. 1;

FIG. 3 shows an embodiment of the verification process shown in FIG. 1;

FIG. 4 shows a flowchart of an embodiment of the spatial verification step shown in FIG. 3;

FIG. 5 shows a flowchart of an embodiment of the structure confidence step shown in FIG. 4;

FIG. 6 shows a flowchart of an embodiment of the temporal verification step shown in FIG. 3;

FIG. 7 shows a flowchart of an embodiment of the post-processing step shown in FIG. 1;

FIG. 8 shows a flowchart of an embodiment of the detection step shown in FIG. 1;

FIG. 9 shows a flowchart of an embodiment of the verification step shown in FIG. 1; and

FIG. 10 depicts further details of the embodiment of the detection process shown in FIG. 2.

### DETAILED DESCRIPTION OF THE INVENTION

The present invention addresses the removal of textual and graphic overlays from video. For the purposes of the present invention, the overlays to be extracted from video are static. By static, it is meant that the overlay remains in a single location in each of a succession of video frames. For example, during a video of a sporting event, an overlay may be located, say, in the bottom right corner of the video, to show the current score. In contrast, an example of a dynamic overlay (i.e., one that is not static) is the scrolling of credits at the end of a movie or television program.

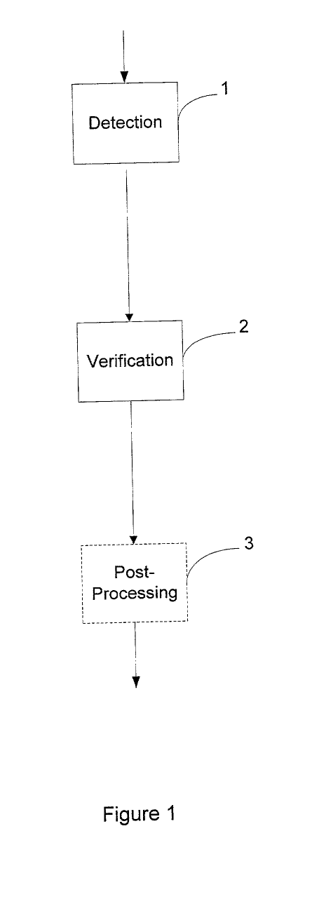

FIG. 1 depicts an overall process that embodies the inventive method for extracting overlays. Video first undergoes a step of detection 1, in which candidate overlay blocks are determined. These candidate overlay blocks comprise sets of pixels that, based on the detection results, may contain overlays. The candidate overlay blocks are then subjected to a process of verification 2, which determines which, if any, of the candidate overlay blocks are actually likely to be overlays and designates them as such. In some embodiments, following verification, the blocks designated as overlays are then subjected to post-processing 3, to refine the blocks, for example, by removing pixels determined not to be part of an overlay.

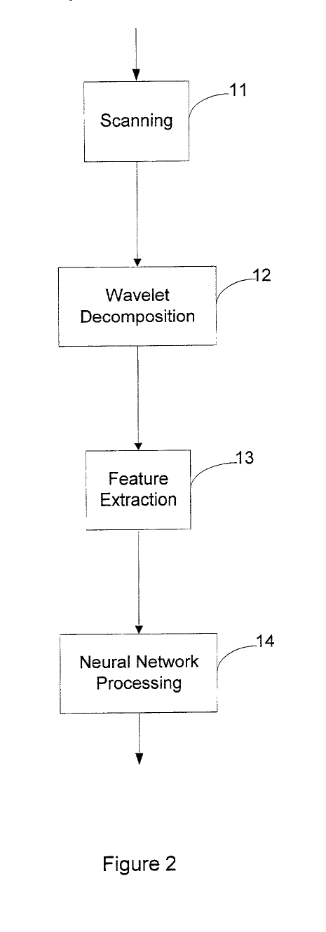

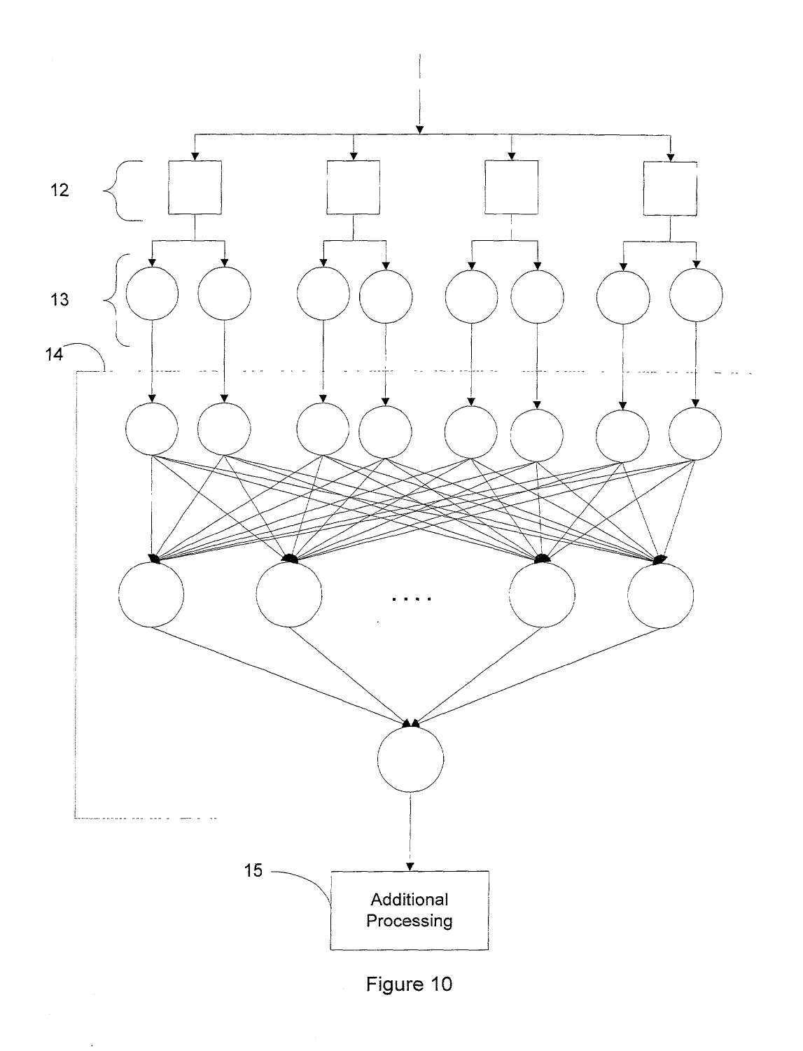

FIGS. 2 and 11 show an embodiment of the detection step 1 directed to the extraction of text overlays. Note that this embodiment may be combined with a further embodiment discussed below to create a method for detecting both textual and graphic overlays. In FIG. 2, the video is scanned in Step 11. Prior to scanning, the video frames may be decomposed into “image hierarchies” according to methods known in the art; this is particularly advantageous in detecting text overlays with different resolutions (font sizes). Scanning here means using a small window (in an exemplary embodiment, 16×16 pixels) to scan the image (i.e., each frame) so that all of the pixels in image are processed based on a small window of surrounding pixels. Following scanning 11, the video is subjected to wavelet decomposition 12, followed by feature extraction 13 based on the wavelet decomposition 12. The extracted features are then fed into a neural network processing step 14. In a preferred embodiment, shown in FIG. 10, the neural network processing step entails the use of a three-layer back-propagation-type neural network. Based on the features, neural network processing 14 determines whether or not the features are likely to define a textual overlay. This may be followed by further processing 15; for example, in the case in which image hierarchies are used, further processing 15 may entail locating the candidate overlay blocks in the various hierarchy layers and re-integrating the hierarchy layers to restore the original resolution.

Text overlays are characterized by low resolution compared to, for example, documents. Also unlike documents, text overlays may vary widely in terms of their characteristics like font size, style, and color, which may even vary within a single overlay. The neural network 14 is, therefore, trained so as to be able to account for such features. By so doing, it classifies each pixel of an image as either text or non-text, providing a numerical output for each pixel. In one embodiment of the invention, the classification is based on the features of a 16-pixel by 16-pixel area surrounding each pixel. The pixels are then grouped into likely overlay areas, by grouping together adjacent pixels whose numerical output values result in their being classified as text, in further processing step 15.

The results of detection step 1 are rather coarsely defined and may give rise to inaccuracies, such as “false alarms” (i.e., detection of overlays where overlays do not actually exist). However, many prior art approaches to text overlay extraction stop at this point. In contrast, the inventive method follows detection 1 with verification 2 to improve accuracy. Verification 2 will now be discussed for the case of textual overlays.

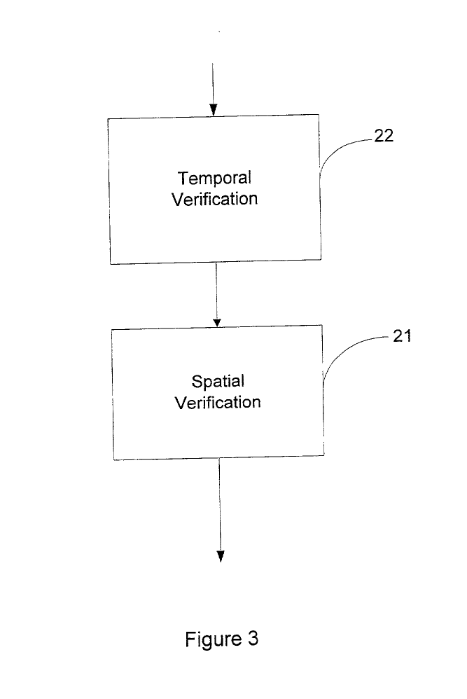

An embodiment of verification 2 is shown in FIG. 3. FIG. 3 shows two steps: temporal verification 22 and spatial verification 21. Temporal verification 22 examines the likely overlay areas identified in detection 1 to determine if they are persistent (and thus are good candidates for being static overlays). Spatial verification 21 examines the areas identified by termporal verification 22 in each particular frame to determine whether or not it may be said with a relatively high degree of confidence that the any of the candidate areas is actually text.

As shown in FIG. 3, likely overlay areas from detection 1 are first subjected to temporal verification 22. The idea behind temporal verification 22 is that a static overlay will persist over a number of consecutive frames. If there is movement of the text or graphics, then it is not a static overlay. To determine whether or not there is movement, and thereby verify the existence of a static overlay, each likely overlay area will be tracked over some number of consecutive frames.

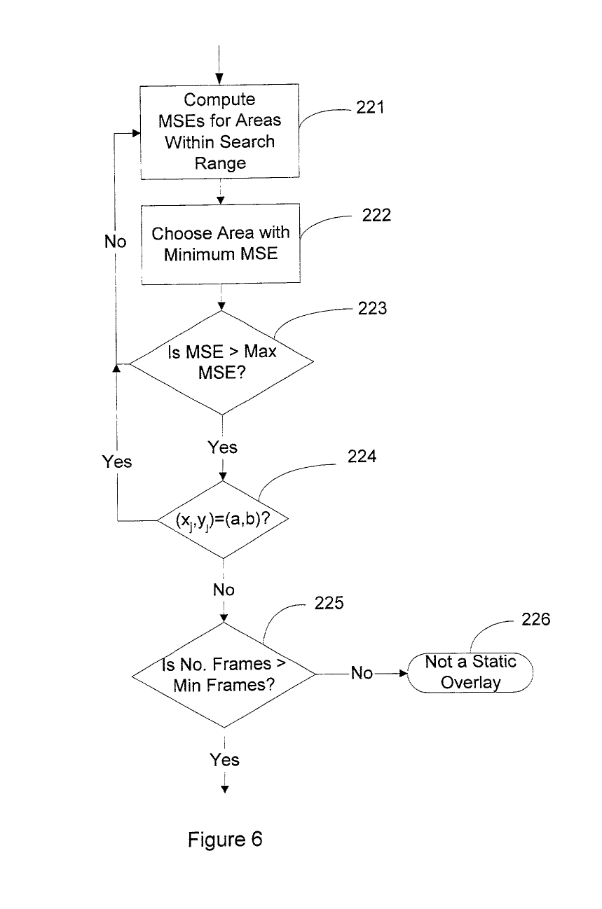

FIG. 6 depicts a flowchart of an embodiment of the temporal verification process 22. As shown, the algoritlun proceeds as follows. Let K(i,j) represent the intensity of the i,jth pixel of the frame in which a likely overlay area is detected by detection step 1, and let I(i,j) represent the intensity of the i,jth pixel of a subsequent frame. Furthermore, let (a,b) represent the coordinates of a particular pixel of the likely overlay area in the frame in which it is detected. The algorithm depicted first involves the computation 221 of a mean square error (MSE), ε, over the pixels in a given likely overlay area over a set of candidate areas in each subsequent consecutive frame. The candidate areas for the frame are selected by considering a search range about the detected location (in the frame in which it is originally detected) of the likely overlay area, where each candidate area corresponds to a translation of the likely overlay area from its detected location in the horizontal direction, the vertical direction, or both. In a particular embodiment, a search range is given by a translation in each direction; in an exemplary embodiment, the translation may be 32 pixels in each of the four directions (positive and negative horizontal and positive and negative vertical). Suppose that a given likely overlay area is M×N pixels in size; then the MSE may be expressed in the form

$$ϵ = \frac{1}{MN} {\sum }_{i = 1}^{M} {\sum }_{j = 1}^{N} {( I ( i , j ) - K ( i , j ) )}^{2} ,$$

where it is assumed that the indices of K(i,j) have been translated if the particular MSE is being computed for a translation of the likely overlay area.

The results of step 221 are a set of MSEs for the various translations of the likely overlay area for the given (subsequent) frame. From these MSEs, a minimum one is selected, and the area (i.e., translation) corresponding to that minimum MSE is selected 222 as the location of the likely overlay area in that frame. Additionally, the coordinates corresponding to the particular pixel (i.e., the pixel having the coordinates (a,b) in the frame in which the likely overlay area was detected) are recorded for the selected minimum MSE. The selected MSE is then compared with a predetermined maximum MSE (“Max MSE”) 223. In an exemplary embodiment, Max MSE=50. If the MSE is less than Max MSE, then it is determined whether the recorded coordinates corresponding to the particular pixel, denoted (xj,yj) in FIG. 6, are equal, or approximately equal, to (a,b) 226. By “approximately equal,” it is meant that the recorded coordinates may differ from (a,b) by some predetermined amount; in one exemplary embodiment, this amount is set to one pixel in either coordinate. If the coordinates are not (approximately) equal, then a count is incremented 227. This count keeps track of the number of consecutive frames in which the recorded coordinates differ from (a,b). The count is compared to a predetermined threshold, denoted Max Count in FIG. 6, to determine whether the count is below Max Count 228. Max Count represents a maximum number of frames in which the recorded coordinates may differ; in an exemplary embodiment, Max Count is a whole number less than or equal to six. If the count is below Max Count, then the method returns to step 221 to restart the process for the next (subsequent consecutive) frame. If, on the other hand, the count is not less than Max Count, then step 224 is executed, as discussed below.

If the coordinates are determined, in step 226, to be (approximately) equal, then the count is cleared or decremented 229, whichever is determined to be preferable by the system designer. Whether clearing or decrementing is chosen may depend upon how large Max Count is chosen to be. If Max Count is small (for example, two), then clearing the count may be preferable, to ensure that once the coordinates are found to match after a small number of errors, a single further error will not result in the method coming perilously close to deciding that tracking should cease; this is of particular concern in a noise environment. On the other hand, decrementing may be preferable if Max Count is chosen to be large (for example, five), in order to prevent a single non-occurrence of a match from resetting the count in the case of a run of consecutive errors. Following decrementing or clearing 229, the method returns to step 221 to restart the process for the next (subsequent consecutive) frame.

If the MSE is greater than Max MSE or the count exceeds Max Count, this indicates that the likely overlay area may no longer be the same or that it may no longer be in or near its original location. If this is the case, then step 224 is executed to determine whether or not the likely overlay area persisted long enough to be considered a static overlay. This is done by determining whether or not the number of subsequent consecutive frames processed exceeds some predetermined number “Min Frames.” In general, Min Frames will be chosen such that a viewer would notice a static overlay. In an exemplary embodiment of the invention, Min Frames corresponds to at least about two seconds, or at least about 60 frames. If the number of frames having an MSE less than Max MSE (and constant coordinates of the particular pixel) exceeds Min Frames, then it is determined that the likely overlay area is a candidate overlay, and the process proceeds to spatial verification 21. If not, then the likely overlay area is determined not to be a static overlay area 225.

To further explain the method of FIG. 6, suppose that the coordinates of the center of the likely overlay area are (a,b) and that steps 221 and 222 result in a sequence of L areas (in consecutive frames) having center points (Xᵢ,Yⱼ), (x2,y2) . . . (X_{L},Y_{L}). If the likely overlay area is to be considered a candidate overlay, then, as discussed above, it must be persistent, which means that (x₁,y₁), (X₂,y₂) . . . (X_{L},y_{L}) should lie at or near (a, b). Furthermore, the overlay may not otherwise change (if it does, then it is not static).

The MSE provides an indication as to how much of a correlation there is between the likely overlay area and its translations in subsequent consecutive frames, with the minimum MSE area in each frame likely corresponding to the likely overlay area. Should the minimum MSE detected in a given frame be too large (as in step 223), then this is an indication that either the overlay may not be static, for example, due to change, disappearance, or movement, and therefore, for the purposes of the invention, may not be an overlay (i.e., it is not static).

It is, however, possible that the minimum MSE may fail to exceed Max MSE even though the overlay location has changed (this may be due to, for example, excessive noise). For this reason, step 226 tests the position of a particular pixel, say, (a,b), with corresponding positions of the same pixel in each subsequent consecutive frame, say, (x₁,y₁), (x₂, y₂) . . . (x_{L},y_{L}).

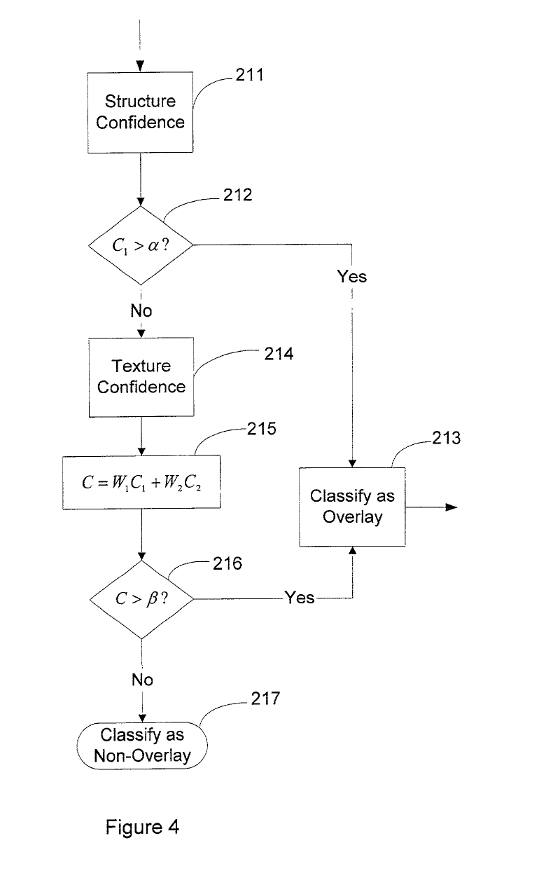

If a likely overlay area is determined by temporal verification 22 to be a candidate overlay, it is passed to step 21 for spatial verification. FIG. 4 depicts an embodiment of spatial verification 21. This embodiment comprises a series of confidence determinations 211 and 214. Each of confidence determinations 211 and 214 operates on a candidate overlay to determine a numerical measure of a degree of confidence with which it can be said that the detected area is actually text. The numerical measures are then tested in Steps 212 and 216, respectively, the latter following a weighting process, to determine whether or not there is sufficient confidence to establish that the detected area is actually text.

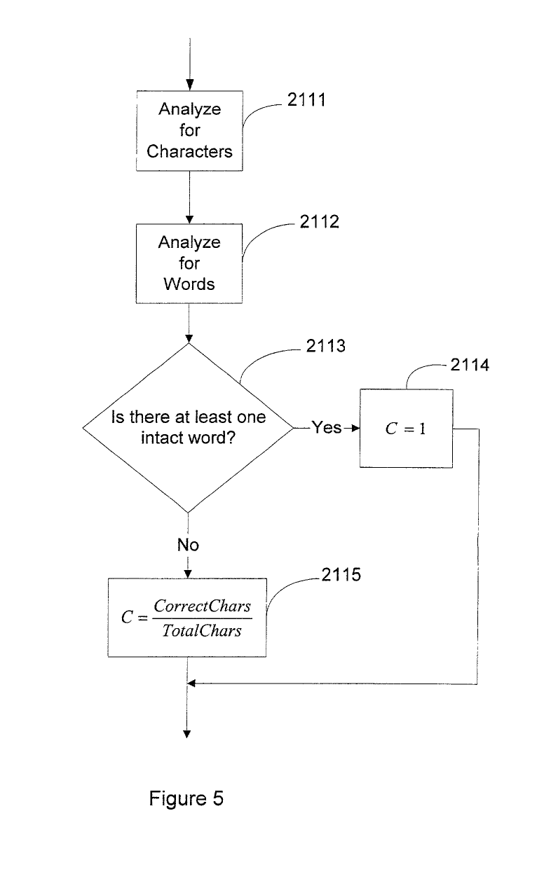

Confidence determination 211 comprises a step of determining structure confidence. An embodiment of this step is depicted in FIG. 5. As shown, a detected area is first analyzed to determine if there are recognizable characters (letters, numbers, and the like) present 2111. This step may, for example, comprise the use of well-known character recognition algorithms (for example, by converting to binary and using a general, well-known optical character recognition (OCR) algorithm). The characters are then analyzed to determine if there are any recognizable words present 2112. This may entail, for example, analyzing spacing of characters to determine groupings, and it may also involve comparison of groups of characters with a database of possible words. Following the step of analyzing for words 2112, if it is determined that at least one intact word has been found 2113, confidence measure C₁ is set equal to one 2114. If not, then C₁ is set to the ratio of the number of correct characters of words in the detected area to the total number of characters in the detected area 2115. Correct characters may be determined, for example, by comparing groupings of characters, including unrecognizable characters (i.e., where it is determined that there is some character present, but it can not be determined what the character is), with entries in the database of possible words. That is, the closest word is determined, based on the recognizable characters, and it is determined, based on the closest word, which characters are correct and which are not. Total characters include all recognizable and unrecognizable characters.

Returning to FIG. 4, the result of structure confidence determination 211 is tested in Step 212. In one embodiment, if C₁ exceeds a threshold, α, then the area is tentatively determined to be a textual overlay 213, and if not, the process proceeds to texture confidence determination 214. Here, a is a real number between 0.5 and 1; in an exemplary embodiment, α=0.6.

Texture confidence determination 214 operates based on the numerical values output from the neural network 14 that correspond to the pixels of the detected area. For a given likely overlay area, a numerical confidence measure C₂ is determined by averaging the numerical outputs from neural network 14 for the pixels within the detected area. That is, if C⁽ⁱ⁾ represents the output of neural network 14 for the ith pixel of a given detected area and the detected area consisting of N pixels, then

$$C = \frac{1}{N} {\sum }_{i = 1}^{N} {C}^{( i )} .$$

The output, C₂ of texture confidence determination 214 is then taken along with C₁ to form C, an overall confidence measure determined as a weighted sum of the individual confidence measures 215. Weights W₁ and W₂ may be determined as a matter of design choice to produce an acceptable range of values for C, e.g., between 0 and 1; the weights may also be chosen to emphasize one confidence measure or the other. In an exemplary embodiment, W₁>W_{2,} and W₁+W₂=1.

The resulting overall confidence measure, C, is then compared 216 with a threshold, β. In one embodiment, βis set to 0.5; however, β may be determined empirically based on a desired accuracy. If C>β, then the candidate overlay is determined to be a textual overlay 213, and if not, the detected area is determined not to be an overlay 217 and is not considered further.

As discussed above, the candidate overlay areas determined based on the neural network processing 14 generally contain extraneous pixels, i.e., pixels that are not actually part of the textual overlay. Such extraneous pixels generally surround the actual overlay. It is beneficial in many video processing applications, for example, video compression, if the area of the overlay can be “tightened” such that it contains fewer extraneous pixels. Processing to perform this tightening is performed in an embodiment of the invention in the post-processing step 3 shown in FIG. 1.

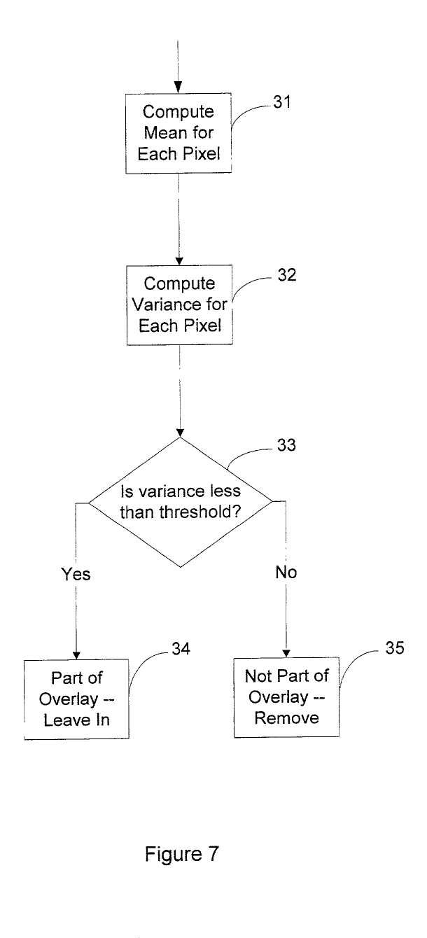

FIG. 7 shows a flowchart of an embodiment of post-processing 3. The general approach of this embodiment is that pixels that actually comprise a static textual overlay should have low temporal variances; that is, objects in the video may move over a set of consecutive frames, or their characteristics may change, but a static textual overlay should do neither. Post-processing 3 begins with the determination of a mean value over a set of M consecutive frames for each pixel 31, followed by a determination of the variance for each pixel 32, also over the set of M consecutive frames. The mean of the ith pixel is the same value,

$${\overline{x}}_{i} = \frac{1}{M} {\sum }_{j = 1}^{M} {x}_{ij} ,$$

determined during temporal verification 22; in a preferred embodiment of the invention, therefore, the mean value for each pixel is passed from temporal verification step 22 to post-processing step 3.

The variance of each pixel is computed as

$${σ}_{i}^{2} = \frac{1}{M} {\sum }_{j = 1}^{M} {( {\overline{x}}_{i} - {x}_{ij} )}^{2} .$$

M is generally taken to be the same number as used in the temporal verification step 22.

Following the computation of the variances for the pixels 32, the variance for each pixel is compared to a threshold 33. If the variance is less than the threshold, then the pixel is considered to be part of the overlay and is left in 34. If not, then the pixel is considered not to be part of the overlay and may be removed 35.

The threshold may be determined empirically and generally depends upon the tolerable amount of error for the application in which the overlay extraction of the present invention is to be used. The greater the threshold, the less likely it is that any actual overlay pixels will be erroneously removed, but the more likely it is that extraneous pixels will not be removed. On the other hand, the lower the threshold, the more likely it is that some actual overlay pixels will be erroneously removed, but the less likely it is that extraneous pixels will not be removed.

Up to this point, the techniques presented have related to textual overlays; however, these techniques may be combined with further techniques to provide a method by which to extract both static textual and static graphical overlays.

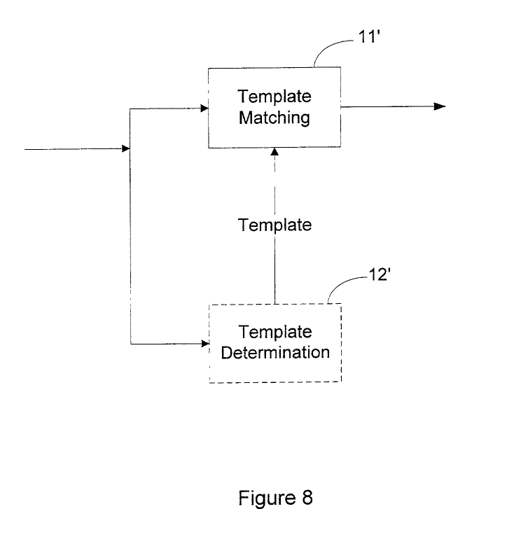

As shown in FIG. 1 and discussed above, the inventive method may be embodied using two steps: a detection process 1 and a verification process 2. A detection process according to an embodiment of the invention is depicted in FIG. 8. The detection process shown in FIG. 8 involves a template matching approach, denoted 11′. There are two possible scenarios for this. First, if the graphical overlay is known, a priori, then a template can be furnished in advance and simply correlated with the video to locate a matching area. On the other hand, if the particular graphical overlay is not known, then a template must be constructed based on the incoming video. This requires a two-pass detection process, in which a template is first determined 12′, and is then passed to the template matching process 11′.

The template determined by template determination 12′ need not be an exact template of the graphical overlay. In fact, as a minimum, it need only provide a location and a size of the graphical overlay. Template determination 12′ may thus be implemented using one or more well-known techniques, including adding the frames together or frame-by-frame image subtraction.

In the case of a moving observer (e.g., a panning camera), a logo or other graphic overlay, even if it remains in the same location in each frame, will appear to be moving relative to the background. In such cases, the simple template determination methods discussed above may fail. In such cases, an alternative approach may be used for template determination 12′. This alternative approach involves image segmentation into background (stationary) objects and foreground (moving) objects. Techniques for performing such segmentation are discussed further in U.S. patent application Serial Nos. 09/472,162 (filed Dec. 27, 1999), 09/609,919 (filed Jul. 3, 2000), and 09/815,385 (filed Mar. 23, 2001), all assigned to the assignee of the present application and incorporated herein by reference in their entireties. Because a graphic overlay will move relative to the background in the case of a moving observer, it will be designated as foreground. The simple techniques above (image addition, frame-by-frame subtraction, or the like) may then be applied only to the foreground to determine a template, which can then be applied in template matching 11′.

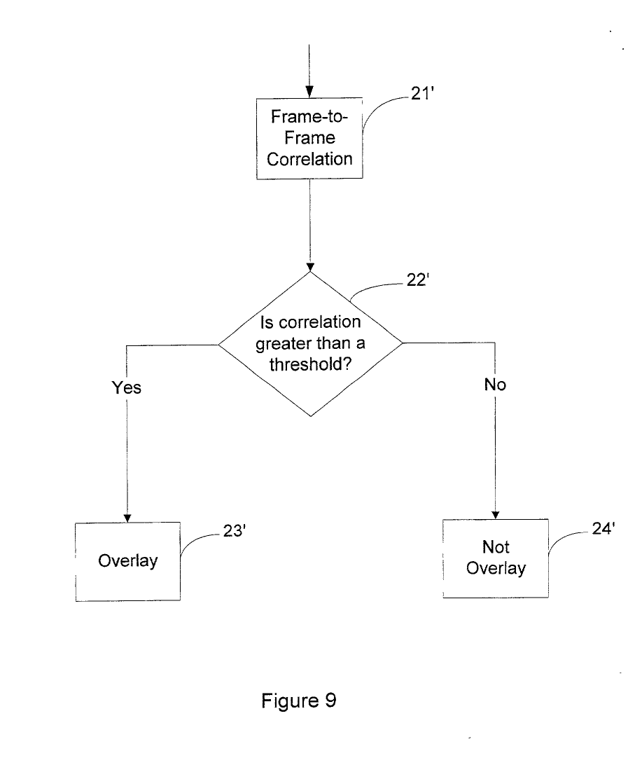

Verification 2 for the case of graphical overlays may be embodied as a process that parallels that used for textual overlays (as shown in FIG. 6). This is depicted in FIG. 9. Frame-to-frame correlation 21′ is performed on the matching results (i.e., candidate overlays) to check if they are persistent over some number of frames (the same numbers of frames applicable to textual overlays are applicable to graphical overlays (e.g., at least about two seconds or 60 frames)). If the correlation exceeds a threshold 22′, then it is determined that the candidate overlay is an overlay 23′; otherwise, it is determined not to be an overlay 24′. Note that the frame-to-frame correlation 21′ may take the form of computing an MSE, and the threshold comparison 22′ may take the form of determining if the MSE falls below a threshold. Regardless, the threshold may be chosen empirically and will depend at least in part on error tolerance, as discussed above in connection with the threshold relevant to FIG. 6.

Note that the template-matching-based approach can also be applied to textual overlays; however, the approach of FIGS. 2-8 and 11 is generally more robust.

Under the assumption that template matching will be used only for graphical overlays, a method for extraction of both types of overlays can be implemented by implementing the methods for textual and graphical overlays either sequentially or in parallel. The parallel approach has the advantage of being more time-efficient; however, the sequential approach has the advantage of permitting the use of common resources in executing both methods.

It is contemplated that the methods for extracting textual and graphical overlays may be embodied as software on a computer-readable medium and/or as a computer system running such software (which would reside in a computer-readable medium, either as part of the system or external to the system and in communication with the system). It may also be embodied in a form such that neural network or other processing is performed on a processor external to a computer system (and in communication with the computer system), e.g., a high-speed signal processor board, a special-purpose processor, or a processing system specifically designed, in hardware, software, or both, to execute such processing.

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

We claim:

1. A method of extracting overlays from video comprising the steps of detecting at least one potential overlay in a video sequence; and verifying that the at least one potential overlay is at least one actual overlay.

2. The method of claim 1, further comprising the step of:
post-processing at least one actual overlay to remove extraneous pixels.

3. The method of claim 2, wherein said step of post-processing comprises the steps of:
computing a variance for each pixel of the at least one actual overlay; and
comparing the variance with a threshold to determine whether or not the pixel should be removed as an extraneous pixel.

4. The method of claim 1, wherein said step of detecting comprises the steps of:
performing wavelet decomposition on the video sequence;
extracting features based on the results of the wavelet decomposition; and
performing neural network processing on the extracted features.

5. The method of claim 4, wherein said neural network processing step comprises the step of:
utilizing three-layer back-propagation neural network processing.

6. The method of claim 4, wherein said step of verification comprises the steps of:
performing temporal verification; and
performing spatial verification.

7. The method of claim 6, wherein said step of temporal verification comprises the steps of:
translating said potential overlay over a search range;
for each translated version of said potential overlay, computing a mean square error in a next video frame of said video sequence subsequent to a video frame in which said potential overlay is originally detected;
determining a minimum of the computed mean square errors for said next video frame; and
comparing the determined minimum mean square error to a threshold.

8. The method of claim 7, further comprising the steps of:
selecting a particular pixel of said potential overlay and recording its coordinates; and
recording the translated coordinates of said particular pixel corresponding to said determined minimum mean square error.

9. The method of claim 8, further comprising the step of:
if the determined minimum mean square error does not exceed said threshold, determining if the coordinates of said particular pixel of said potential overlay match said translated coordinates of said particular pixel corresponding to said determined minimum mean square error.

10. The method of claim 9, wherein said determining step determines an approximate match.

11. The method of claim 9, further comprising the step of:
if said determining step determines that there is not a match, performing the sub-steps of:
incrementing an error count; and
comparing said error count to a predetermined threshold; and
if said determining step determines that there is a match, decreasing said error count.

12. The method of claim 11, wherein said step of decreasing said error count comprises the step of decrementing said error count.

13. The method of claim 11, wherein said step of decreasing said error count comprises the step of clearing said error count.

14. The method of claim 11, wherein said steps of computing, determining, recording, and comparing are performed for subsequent video frames of the video sequence as long as said determined minimum mean square error is found not to exceed said threshold and either the coordinates of said particular pixel of said potential overlay match said translated coordinates of said particular pixel corresponding to said determined minimum mean square error or said error count does not exceed said predetermined threshold.

15. The method of claim 6, wherein said step of performing spatial verification is performed for a candidate overlay determined by said step of performing temporal verification and comprises the steps of:
determining a structure confidence for said candidate overlay; and
determining a texture confidence for said potential overlay.

16. The method of claim 15, further comprising the steps of:
determining if said structure confidence meets a first threshold test; and
determining if a weighted sum of said structure confidence and said texture confidence meets a second threshold test.

17. The method of claim 16, wherein said step of said step of determining a texture confidence is performed only if said structure confidence fails to meet said first threshold test.

18. The method of claim 17, wherein if either of said steps of determining if said structure confidence or said weighted sum meets said respective first or second threshold test is satisfied for the candidate overlay, the candidate overlay is declared to be an overlay; and wherein said steps of determining if said structure and weighted sum meet said respective first and second threshold tests are not satisfied for the candidate overlay, the candidate overlay is determined not to be an overlay.

19. The method of claim 15, wherein said step of determining a structure confidence comprises the steps of:
analyzing the candidate overlay to determine characters;
analyzing the determined characters for the presence of words; and
setting a numerical value for said structure confidence depending upon the presence of one or more intact words.

20. The method of claim 19, wherein said step of setting a numerical value comprises the steps of:
setting the structure confidence equal to one if at least one intact word is detected; and
if no intact word is detected, setting the structure confidence equal to a number of correct characters divided by a total number of characters.

21. The method of claim 15, wherein said step of determining a texture confidence comprises the step of:
setting the texture confidence equal to an average value of outputs of said neural network processing step corresponding to all the pixels in a potential overlay.

22. The method of claim 1, wherein said step of detecting comprises the step of: performing template matching to determine the presence of a potential overlay.

23. The method of claim 22, wherein said step of detecting further comprises the step of:
determining a template to be used in said step of performing template matching.

24. The method of claim 22, wherein said step of verifying comprises the steps of:
performing frame-to-frame correlation of said potential overlay; and
comparing a result of the frame-to-frame correlation with a threshold to determine if the potential overlay is an actual overlay or not.

25. The method of claim 24, wherein said step of performing frame-to-frame correlation comprises the step of:
forming a mean square error over a set of frames from said video sequence, averaged over all of the pixels in said potential overlay.

26. A computer-readable medium containing software embodying the method of claim 1.

27. A computer system comprising:
a computer; and
a computer-readable medium containing software embodying the method of claim 1.

28. A computer system comprising:
a computer;
a computer-readable medium containing software embodying the method of claim 4; and
an external processor, in communication with said computer, on which is performed the step of neural network processing.

29. A method of extracting textual and graphical overlays from video, comprising the steps of:
detecting at least one potential overlay in a video sequence, said detecting comprising the steps of:
performing wavelet decomposition on the video sequence;
extracting features based on the results of the wavelet decomposition;
performing neural network processing on the extracted features; and
in parallel with said steps of performing wavelet decomposition, extracting features, and performing neural network processing, performing template matching; and
verifying that the at least one potential overlay is at least one actual overlay.

30. The method of claim 29, wherein said step of verifying includes the step of:
performing temporal verification.

31. A method of extracting textual overlays from video, comprising the steps of:
detecting at least one potential overlay in a video sequence, said detecting comprising steps of:
performing wavelet decomposition on the video sequence;
extracting features based on the results of the wavelet decomposition; and
performing neural network processing on the extracted features; and
verifying that the at least one potential overlay is at least one actual overlay.

32. The method of claim 31, wherein said step of verification comprises the steps of:
performing temporal verification; and
performing spatial verification.

33. The method of claim 32, wherein said step of spatial verification is performed for a candidate overlay output by said step of temporal verification and comprises the steps of:
determining a structure confidence for said candidate overlay;
determining a layout confidence for said candidate overlay; and
determining a texture confidence for said candidate overlay.

34. The method of claim 32, wherein said step of performing temporal verification comprises the steps of:
computing a mean square error for each pixel of said potential overlay over a set of video frames of said video sequence;
averaging said mean square error for each pixel over all of the pixels in said potential overlay, thus producing an average mean square error; and
comparing said average mean square error to a threshold to determine if the potential overlay is a candidate overlay or not.

35. A method of extracting graphical overlays from video, comprising the steps of:
detecting at least one potential overlay in a video sequence, said detecting comprising the step of:
performing template matching; and
verifying that the at least one potential overlay is at least one actual overlay, said verifying comprising the step of:
performing frame-to-frame correlation of a potential overlay determined by said detecting step.

36. The method of claim 35, wherein said step of detecting further comprises the step of:
determining a template to be used in said step of performing template matching.

37. The method of claim 36, wherein said step of determining a template comprises the step of:
performing addition or frame-by-frarne subtraction of video frames.

38. The method of claim 36, wherein said step of determining a template comprises the steps of:
segmenting video frames into foreground and background objects;
performing correlation tracking to determine if any foreground object remains in the same absolute location in each video frame.
